(19) United States
(12) Patent Application Publication
(10) Pub. No.: US 2006/0100970 A1
(43) Pub. Date: May 11, 2006

(54) Method and system for facilitating package delivery

(75) Inventors: Mary Morony, Keswick, VA (US); Phillip Collier, Charlottesville, VA (US)

Correspondence Address: PETER E ROSDEN, 1505 LONDON ROAD, CHARLOTTESVILLE, VA, 229018881, US

(73) Assignee: EZOTE, L.L.C.

(21) Appl. No.: 10/985,244

(22) Filed: Nov. 10, 2004

(51) Int. Cl. B65B 35/00; G06Q 99/00; G06Q 40/00

(52) U.S. Cl. 705/406; 705/1; 705/37

(57) ABSTRACT

A method and system for facilitating the delivery of one or more packages between parties involved in Internet auctions and other types of transactions in which the sender and the recipient wish to remain anonymous with respect to each other. The sender consigns each package to a third party consignee who assigns a unique identifier to each package and digitally stores that information until a destination location becomes known, for instance, through conclusion of an Internet auction of the item(s) contained in a package. Then, the consignee arranges for each package to be picked up and for a shipping label to be applied only to those packages where the unique identifier on the package matches the unique identifier on the shipping label generated by a common carrier based on data supplied by the consignee. Once the shipping label is applied, the package is delivered to the destination address.

### TECHNICAL FIELD

The subject invention relates generally to a method for enabling the efficient delivery of goods from a seller to a buyer. More particularly, this invention provides a method for facilitating such deliveries when the sale involves a consignment by the seller to a third party and requires delivery through of the sold goods to the buyer by a transportation provider.

### BACKGROUND OF THE INVENTION

The use of common carrier services to pickup and deliver packages from one place to another is well known. Typically, the shipper either completes a delivery label which includes both the shipper's name and address and the name and address of the recipient and then calls the common carrier to request a pickup from a specified location during a specified time period. Payment is made directly to the common carrier by check, credit card charge or electronic funds transfer.

Also known is the process for returning goods to a commercial seller for any of a variety of reasons. In this situation, the return process is controlled by the seller. The purchaser usually calls the seller and requests a return pickup from the seller. The seller then instructs the purchaser to place a return label which is often prepared and included with the initial purchase receipt on the rewrapped package containing the goods to be returned. The seller then advises the purchaser approximately when to expect a pickup. A common carrier is then contacted by the seller and a pickup is requested. The common carrier executes the pickup and returns the package to the seller whose name and address are indicated on the previously prepared return label.

With the advent of auctions occurring on the Internet in which goods are listed for sale on a website and sold to the highest bidder, the possibility has developed for the owners of goods to sell property without having to become actively involved in locating purchasers and without the need to deal directly with such purchasers. But some potential sellers are intimidated by a perception that Internet auctions are too complex while others simply do not have the time or desire to learn the process of participating in Internet auctions. Not only must a seller list goods following the auction website's specified procedures and handle payment collection details, but at the conclusion of such auctions, the seller must obtain the name and address information of the purchaser, enter them on a common carrier label, package the sold goods, apply that label to the package, contact a common carrier to request a pickup and present the package to the common carrier often together with payment for the delivery service. Consequently, services have developed to assist sellers by eliminating these steps and taking over all of the details involved in the auction process in return for a fee.

However, common carrier services such as UPS®, Federal Express®, DHL® and even the United States Postal Service® are not structured to allow their pickup personnel to enter names and addresses on packages. Instead, their personnel typically follow rigid procedures, and the organizations for which those personnel work are often too monolithic to make a change in those procedures to add and accommodate a destination label completion service. Moreover, they have no incentive to make such a change since it carries with it a much higher risk of error and, hence, financial liability along with a greater expenditure of time by pickup personnel thereby reducing their efficiency. The same reasons explain why an auction assistance service does not want to be responsible for manually entering a purchaser's name and address on each package. Thus, in order to accommodate the goal of assisted auction services of substantially eliminating an auction seller's involvement in the delivery process after an auction has been successfully concluded, a need exists for a procedure through which packages initially bearing no destination address can be picked up from an auction seller by a common carrier and successfully delivered to an auction purchaser. The same need exists for any delivery service where it is desired to maintain anonymity as between the sender and the recipient.

### SUMMARY OF THE INVENTION

This invention relates to a system and method for facilitating the delivery of one or more packages containing one or more items from an origination location to a destination location where identifying information concerning the sender and recipient do not appear on shipping labels, thereby enabling the sender and recipient to remain anonymous with respect to each other. The sender acts as a consignor and requests that a third party consignee sell the one or more items, such as through an online auction process. The consignee typically sends a representative to the origination location to wrap one or more items in separate packages, as necessary and to assign a unique identifier to each resulting package which is affixed in some manner to that package. That identifier is digitally linked as identifying data together with the contents and weight of a specific package and is transmitted to a location designated by the consignee. When a destination location becomes known, such as after a successful sale of items in one or more packages has occurred, the consignee arranges for a common carrier to pickup the package or packages containing items which have been sold from the origination location and advises the consignor of the scheduled pickup. After transmission of the identifying data from the consignee to a common carrier responsible for picking up and delivering the at least one package from the origination location, the common carrier generates a shipping label for each package containing the unique identifier and information concerning the destination location. Upon arrival at the origination location, the common carrier compares the unique identifier affixed to all packages made available at the origination location with the identifier appearing on the shipping label, and, if a match is confirmed, affixes the shipping label to the matching package. If more than one package is to be picked up, another shipping label is generated and further comparisons are undertaken. Each package onto which a shipping label has successfully been placed is then delivered to its respective destination location. If no package matches a particular identifier appearing on a shipping label, the pickup for that package is aborted.

### BRIEF DESCRIPTION OF THE DRAWINGS

The foregoing and other objects, aspects and advantages of the invention will be better understood from the following detailed description of the invention with reference to the drawings, in which:

FIG. 1 illustrates the participants in the delivery method of this invention.

FIG. 2 illustrates a special label used in the delivery method of this invention.

FIGS. 3A and 3B present in block diagram form the process of the delivery method of this invention.

### DETAILED DESCRIPTION OF THE PREFERRED EMBODIMENT

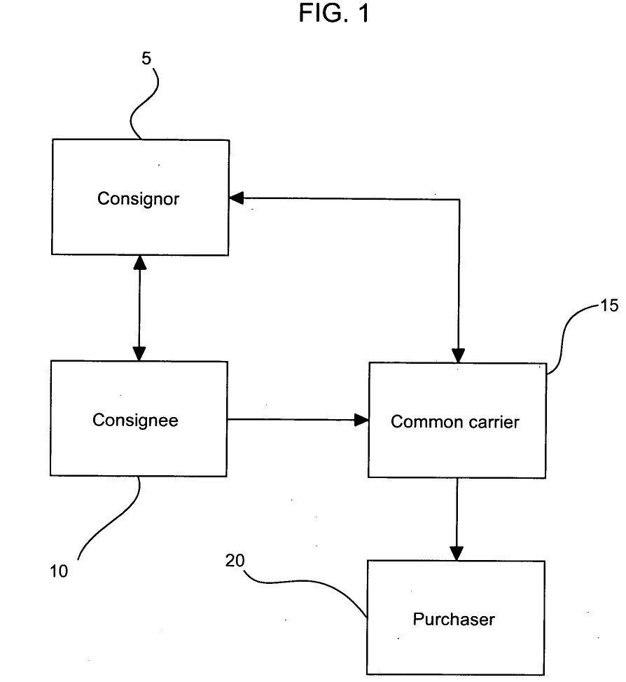

For a more detailed understanding of the invention, reference is first made to FIG. 1 of the drawings in which the participants in executing the preferred delivery method of this invention are illustrated schematically. Consignor/seller 5 typically contacts a consignee 10, which is a third party auction assistance service, by telephone, email or otherwise in order to sell one or more specified items retained by consignor 5 by means of an auction. After the auction is complete, consignee 10 contacts common carrier 15 which picks up one or more packages containing sold items from consignor 5 at an origination location and delivers them to recipient/purchaser 20 at a destination location. The package may be of any size and configuration and may contain any type of goods including electronic data stored digitally on a medium such as a compact disk or any data storage device. The common carrier may be any delivery service, including, but not limited to, United Parcel Service®, Federal Express®, DHL® or the United States Postal Service®.

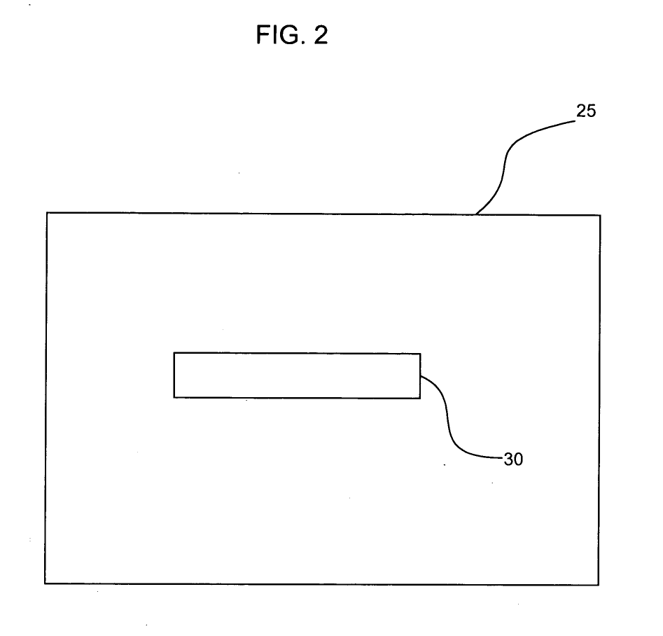

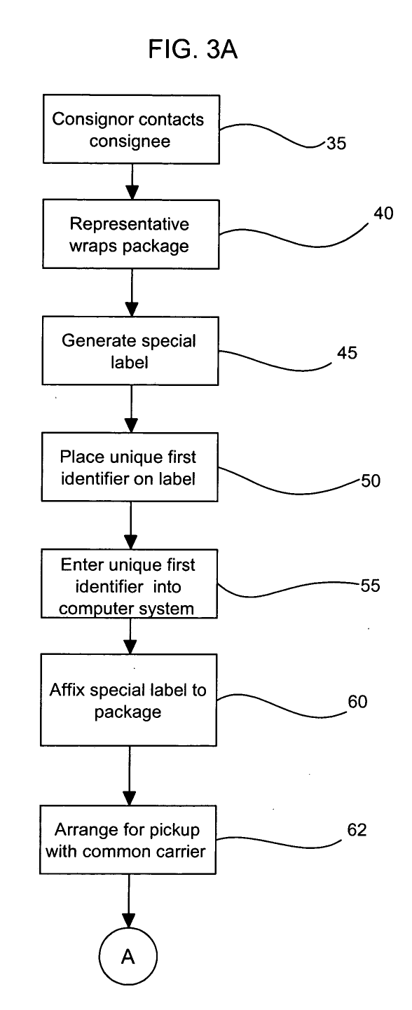

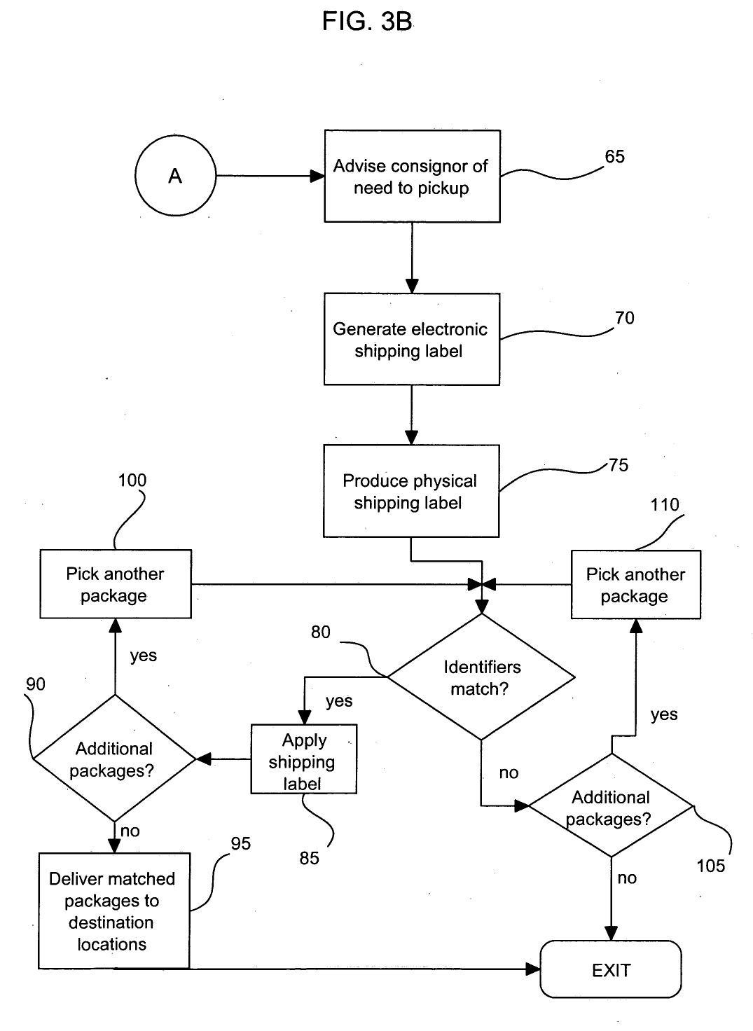

FIG. 2 illustrates a special label 25 which is placed on each of the packages of consignor 5 as described below with regard to FIG. 3. Label 25 provides contact information for consignor 5 and includes a space which may be at any place on the label and in which is entered a unique identifier 30. Identifier 30 is preferably a bar code but may also be a handwritten or machine-generated number or any other form of electronic or visual identification and may be analog or digital. For example, identifier 30 may be numeric, alphanumeric, text, color-coded, optic-coded, bar-coded or any other type of indication format which is uniquely distinguishable from other types of indication formats. Label 25 may also include written or digitally coded instructions to common carrier 15.

FIG. 3 illustrates in greater detail the delivery process of this invention. At 35, consignor 5 contacts consignee 10 to enter a request to sell one or more products by auction on the Internet. At 40, a representative of consignee 10 goes to the location of consignor 5 and wraps each of the items designated for sale in separate packages. The representative at 45 then either generates a special label 25 for each resulting package on site or uses one of a number of pre-generated blank special labels which the representative carries. At 50, unique identifier 30 is generated and placed onto special label 25 into a predesignated space either manually by hand or through further generation of an adhesive label which is affixed into the predesignated space. This identifier 30 is then entered at 55 by means of scanning or manual entry into a portable computing device which digitally associates it and links it together with origination location address and the weight and description of the contents of each package at the origination location as identifying data for that package and either transmits that information as well as the total number of packages at the origination location back to a specified location of consignee 10 or retains the information until it is later downloaded into a central computer at a specified location of consignee 10. Alternatively, the process of generating label 25 could include automatic generation of first identifier 30 and automatic association of the identifier with the contents of the package to which it is affixed. Similarly, a microchip could be substituted for label 25 if it is desired to employ radio frequency identification (RFID) technology. Each identifier 30 remains uniquely linked to its associated package until either the package is delivered, as discussed below, or consignor 5 or consignee 10 cancels the transaction for another reason. In this way, confusion in identifying packages is eliminated. Each special label 25 is then affixed at 60 to the package with which its unique identifier 30 is associated.

Following successful sale of and receipt of payment for the items contained in one or more packages, consignee 10 contacts common carrier 15 at 62 to advise common carrier 15 of the pickup location and the number of packages to be picked up and to arrange for a date and approximate time for pickup to occur. Then, consignee 10 advises consignor 5 at 65 which of the one or more wrapped and labeled packages need to be picked up and that a employee of common carrier 15 will arrive to pickup the package(s) on a certain day within a certain time window. Consignor 5 can then either leave the one or more packages at a designated location outside of the pickup location or plan to meet the pickup personnel of common carrier 15 to present the package(s) for further handling. Then, at 70, using either its own software or proprietary software of common carrier 15, consignee 10 generates through known means a digital version of a shipping label for each package to be picked up which it transmits to common carrier 15. Each digital shipping label includes at least (1) the identifying data for each package to be picked up at a specified origination location; (2) the destination location address of purchaser 20 for each package to be picked up at the origination location; and (3) instructions to the pickup driver of common carrier 15 to apply the shipping label only after matching the identifier appearing on the shipping label generated for the pickup location with unique identifier 30 on a package at the pickup location. Otherwise, each shipping label may be configured and contain such other information as is required by common carrier 15.

Prior to package pickup, the shipping label is converted at 75 by printing or otherwise into a physical label either at the dispatch location of common carrier 15 or by use of equipment accompanying the pickup personnel assigned with the responsibility of retrieving the package. The data on the shipping label may also be retained in a portable computing device carried by the pickup personnel. Unique identifier 30 on special label 25 is then compared at 80 with the identifier contained in the identifying data on the shipping label either by manual comparison of the identifiers or, preferably, by digital automated comparison of the data in a portable computing device of the pickup personnel after scanning unique identifier 30 from special label 25 on each package presented for pickup. The automated comparison can be based, for example, on optical character recognition (OCR) or on bar-, optic- or color-reader software. Once a successful comparison has occurred, the shipping label is applied to the matched package at 85. Each package for which a successful match has occurred is treated by the common carrier as a “return item”. In other words, in each such case, the package is viewed by the common carrier's delivery system as being returned to the original sender who is actually, in the circumstances described herein, the purchaser of the item(s) in the package. In this way, no identifying information from the consignor appears on the exterior of the package when it is delivered to the purchaser, and, similarly, the consignor does not view the shipping label bearing the purchaser's identifying information which is prepared and applied by the common carrier's employee. If there are no additional shipping labels for the pickup location as determined at 90, all packages to which shipping labels have been applied are handled like any other package by common carrier 15 until their ultimate delivery to purchaser 20 at 95 and the process is exited. If there are additional shipping labels for the pickup location, another package is picked at 100 and another attempt is made to match the unique identifier at 80. If the unique identifier did not match at 80 and there are additional packages available for comparison at the shipping location, as determined at 105, another package is picked at 110 and a further attempt is made to match the unique identifier at 80. If there are no additional packages, the process is exited.

Thus, through use of the system and method of this invention, the delivery aspect of Internet auctions is greatly facilitated and simplified. Each package containing an auctioned item has associated with it a unique identifier throughout the life cycle from request for transportation until actual delivery occurs or the transaction is otherwise terminated. Consequently, the seller and purchaser may remain anonymous with respect to each other since they have no direct contact with each other throughout a transaction and do not know each other's names and/or addresses. The work and time investment required of a seller participating in an online auction on whose behalf the method and system of this invention is employed is therefore substantially reduced.

The method and system of this invention are not limited to Internet auctions but can be applied broadly to any type of sale transaction in which the seller and purchaser have no direct contact or knowledge of each other and the transaction, including delivery of goods sold, is handled by one or more third parties. The process steps disclosed are not the only way in which the function of this invention can be implemented. Other embodiments and sequences of steps are possible so long as the overall structure, method and advantages described above are preserved.

What is claimed is:

1) A method for delivering at least one package containing one or more items to be sent from a consignor at an origination location to a recipient at a destination location using a consignee to arrange the shipment and a common carrier to transport the shipment between the origination and destination locations wherein the consignor and the recipient have no knowledge of either the identity or location of each other, comprising:
generating a unique identifier for each package at the origination location;
associating one said unique identifier with each package at the origination location with that package;
linking together as identifying data each said unique identifier with the contents and weight of the package to which it is affixed and the origination location; and
transmitting for each package at the origination location said identifying data to a further location specified by the consignee;
arranging with the common carrier the date on and approximate time at which at least one package will be picked up at the origination location;
conveying said identifying data and the destination location to the common carrier;
advising the consignor that at least one package will be retrieved by a common carrier within a window of time on a specified date;
creating a shipping label displaying the destination location and all of said identifying data except the origination location;
retrieving at least one package from the origination location;
comparing said unique identifier affixed to the package with the unique identifier appearing on said shipping label as part of said identifying data;
applying said shipping label to the retrieved package if the comparison produces a match;
returning to the retrieving step if there are additional packages at the origination location; and
delivering each package to which a shipping label has been applied to its specified destination location.

2) The method of claim 1 wherein the associating step is preceded by the steps of:
requesting that at least one item be sold by the consignee; and
wrapping at least one item in at least one package at the origination location by the consignee.

3) The method of claim 1 wherein the associating step further includes either:
manually affixing a separate special label bearing said unique identifier to each package; or
attaching an RFID or similar microchip device encoded with said unique identifier to the package with which said unique identifier is associated.

4) The method of claim 1 wherein said transmitting step requires temporary storage of said identifying data for later transfer to a computing device at a location specified by the consignee.

5) The method of claim 1 wherein said transmitting step requires substantially immediate electronic transmission of digital information after completion of the associating step to a location specified by the consignee.

6) The method of claim 1 wherein said advising step is preceded by the step of:
arranging with the common carrier the date on and approximate time at which at least one package will be picked up at the origination location.

7) The method of claim 1 wherein said creating step further includes:
generating an electronic shipping label;
providing the common carrier with the electronic shipping label; and
giving the common carrier's retrieval personnel either a physical shipping label alone or both a physical shipping label and an electronic version of the shipping label.

8) The method of claim 1 wherein said unique identifier is any one or more selected from the group consisting of a number, an alphanumeric combination, a combination of letters, a color code, an optical code or a bar code.

9) The method of claim 8 wherein said unique identifier may be handwritten, manually generated or machine generated.

10) A method for delivering one or more packages from a sender at an origination location to a recipient at a destination location wherein the sender and recipient remain anonymous with respect to each other and the shipment is handled entirely by a third party and a common carrier comprising:
associating as identifying data a separate unique identifier, a content description and a weight with each package at the origination location;
determining the destination location;
advising a common carrier for a package at an origination location of the origination location and of the identifying data associated with that package;
creating a shipping label displaying an identifier and a destination address;
retrieving a package from the origination location;
comparing the unique identifier associated with the retrieved package with the identifier displayed on the shipping label;
if a match occurs, applying the shipping label to the retrieved package and delivering the package to the destination location; and
if there is more than one package at the origination location, returning to the retrieving step.

11) The method of claim 10 wherein the associating step further includes either:
manually affixing a separate special label bearing said unique identifier to each package; or
attaching an RFID or similar microchip device encoded with said unique identifier to the package with which said unique identifier is associated.

12) The method of claim 10 wherein said creating step further includes:
generating an electronic shipping label;
providing the common carrier with the electronic shipping label; and
giving the common carrier's retrieval personnel either a physical shipping label alone or both a physical shipping label and an electronic version of the shipping label.

13) The method of claim 10 wherein said unique identifier is any one or more selected from the group consisting of a number, an alphanumeric combination, a combination of letters, a color code, an optical code or a bar code.

14) The method of claim 13 wherein said unique identifier may be handwritten, manually generated or machine generated.

15) A system for enabling at least one package to be sent from a consignor at an origination location to a recipient at a destination location using a third party shipping service wherein the shipper and the recipient have no knowledge of either the identity or location of each other, comprising:
separate unique identifiers affixed to each package at the origination location
at least one shipping label displaying the destination location and a single unique identifier;
matching means for comparing a unique identifier affixed to a package and a unique identifier displayed on one of said shipping labels;
common carrier means for delivering each package to the destination location for which a match of said unique identifiers has occurred.

16) The system of claim 15 wherein said unique identifier may be any one or more selected from the group consisting of a number, an alphanumeric combination, a combination of letters, a color code, an optical code or a bar code.

17) The system of claim 15 wherein said unique identifier is either handwritten, manually generated or machine generated or any combination thereof.

18) The system of claim 15, wherein said matching means is a comparison based on human vision, OCR, bar-, optic- or color-reader software.
